(19) United States
(12) Patent Application Publication
(10) Pub. No.: US 2020/0191925 A1
(43) Pub. Date: Jun. 18, 2020

(54) SYSTEMS AND METHODS FOR AN APD ARRAY SOLID-STATE LASER RADAR

(71) Applicant: SZ DJI TECHNOLOGY CO., LTD., Shenzhen City (CN)

(72) Inventors: Guoguang ZHENG, Shenzhen (CN); Xiaoping HONG, Shenzhen (CN); Mingyu WANG, Shenzhen (CN)

(73) Assignee: SZ DJI TECHNOLOGY CO., LTD., Shenzhen City (CN)

(21) Appl. No.: 16/797,146

(22) Filed: Feb. 21, 2020

Related U.S. Application Data
(63) Continuation of application No. PCT/CN2017/100036, filed on Aug. 31, 2017.

(51) Int. Cl. G01S 7/4863; G01S 17/894; G01S 7/481

(52) U.S. Cl. CPC G01S 7/4863; G01S 7/4817; G01S 17/894

(57) ABSTRACT

Methods and systems for detecting and ranging an object may include or be configured to carry out the steps of emitting, by a laser light source, a first beam of light incident on a surface of the object, receiving, at an avalanche photodiode (APD) array, a second beam of light reflected from the surface of the object; reading, by a readout integrated circuit (ROIC) array, from the APD array; and processing, by the ROIC array, accumulated photocurrent from the APD array for outputting a signal representative of the object detected by the APD array.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to light detecting and, more particularly, to systems and methods for light detection and ranging (LIDAR) of an object by simultaneously generating a 3-D point cloud and a 2-D image of the object.

### BACKGROUND

LIDAR relates generally to systems and processes for measuring distances to a target object by illuminating the target object with laser light and detecting the reflection of the light. For example, a pulsed laser light device may emit light incident upon a surface of an object, and pulsed light reflected from the surface of the object may be detected at a receiver. A timer may measure an elapsed time from light being emitted from the laser light device to the reflection reaching the receiver. Based on a measurement of the elapsed time and the speed of light, a processing device may be able to calculate the distance to the target object.

The receiver in a LIDAR system may be equipped with sensors such as avalanche photodiodes (APD) to detect reflected light pulses at particular wavelengths. LIDAR systems may also include a scanning mechanism so that the incident laser may scan over multiple points on the target object, and may generate 3-D point clouds that include object distance or depth information. Mechanical LIDAR systems are well known in the art and include mechanical scanning mechanisms to acquire distance information at multiple points of coverage.

For example, a mechanical rotatable LIDAR system may include an upper scanning mechanism and a fixed lower part. The upper scanning mechanism may include a predetermined number of laser-APD pairs, such as 64 laser-APD pairs, and may rotate at 360 degrees and at a fixed frequency, such as 20 Hz. Mechanical rotatable LIDAR systems, however, typically allow only for a single laser-APD pair to be operable at a given time to prevent overheating, maintain device reliability, and prevent detector saturation. As a result, mechanical rotatable LIDAR systems do not simultaneously use all of the laser-APD pairs, resulting in inefficiency.

Mechanical LIDAR systems also have low reliability. For example, mechanical systems require many components, and each part may be susceptible to breakdown or damage. Additionally, given the complex mechanical structure of mechanical LIDAR systems, assembly costs are high. Moreover, since each laser-APD array requires individual alignment, assembly may be burdensome. Accordingly, not only are conventional mechanical LIDAR systems typically unreliable, costly, and burdensome, but also their inefficient use of laser-APD pairs makes it more difficult to detect objects and capture distance and ranging information.

### SUMMARY

The systems and methods for detecting and ranging an object in the embodiments disclosed herein overcome disadvantages of conventional systems.

For example, the disclosed embodiments of the present disclosure provide a solid state laser radar system with the advantages of miniaturization, low cost, high reliability, fast response, and automatic production to detect objects efficiently. In conventional mechanical LIDAR systems, a laser requires emission at small angles with a low field of view (FOV) to concentrate the energy of the beam, and the laser strength must comply with a safety standard. In the disclosed embodiments, however, the solid state laser light source is not bound by the same mechanical safety standard and may be expanded to increase FOV, As a result, the solid state laser source may have a much higher power.

Furthermore, in mechanical LIDAR scanning systems, the laser achieves scanning all points in the FOV by scanning point by point, thus having a longer scan time. In the disclosed embodiments, however, systems may scan all points in the FOV simultaneously at a very high scan rate and at a reduced scan time. Accordingly, a signal to noise (S/N) ratio may be increased by averaging the multiple captures using multiple scanned laser pulses. The solid state laser may also achieve a higher capture frequency. Moreover, the disclosed embodiments provide for the benefit of APD integration such that distance information and image information may be obtained at the same time.

Additionally, since the APD arrangement of the present disclosure is not a single point but instead is an array, information of distances to all the points in the entire FOV of the LIDAR may be obtained. Therefore, complete information of distances may be obtained by rapidly scanning frame by frame. Meanwhile, as compared with conventional mechanical LIDAR systems having only a single scanning point, the response speed of the disclosed embodiments may be very fast, Finally, because no movable mechanical components are needed for systems and methods of the present disclosure, reliability is improved.

In one aspect, the present disclosure relates to a method for detecting and ranging an object. The method includes emitting, by a laser light source, a first beam of light incident on a surface of the object; receiving, at an avalanche photodiode (APD) array, a second beam of light reflected from the surface of the object; reading, by a readout integrated circuit (ROIC) array, from the APD array; and processing, by the ROIC array, accumulated photocurrent from the APD array for outputting a signal representative of the object detected by the APD array.

In another aspect, the present disclosure relates to a system for detecting and ranging an object. The system includes a laser light source configured to emit a first beam of light incident on a surface of the object; an avalanche photodiode (APD) array configured to receive a second beam of light reflected from the surface of the object; and a readout integrated circuit (ROC) array coupled to read and process accumulated photocurrent from the APD array for outputting a signal representative of the object detected by the APD array.

In yet another aspect, the present disclosure relates to a receiver for detecting and ranging an object. The receiver includes an avalanche photodiode (APD) array configured to receive a beam of light reflected from the surface of the object; and a readout integrated circuit (ROIC) array coupled to read and process accumulated photocurrent from the APD array for outputting a signal representative of the object detected by the APD array.

### BRIEF DESCRIPTION OF THE DRAWINGS

FIG. 1 is a schematic diagram of an exemplary LIDAR system;

FIG. 2 is a schematic diagram of an exemplary mechanical rotatable LIDAR system;

FIG. 3 is a schematic diagram of an exemplary system for detecting and ranging an object consistent with embodiments of the present disclosure;

FIG. 4 is a schematic diagram of an exemplary system for laser alignment, laser expansion, uniform illumination, and FOV expansion that may be used with embodiments of the present disclosure;

FIG. 5 is a schematic diagram of a cross-section of an integrated circuit chip including an APD array consistent with embodiments of the present disclosure;

FIG. 6 is a schematic diagram of transimpedance amplifier (TIA) and time-to-digital coverter (TDC) circuits consistent with embodiments of the present disclosure;

FIG. 7 is a schematic diagram of a plan view layout of an integrated circuit chip including an APD array consistent with embodiments of the present disclosure;

FIG. 8 is a schematic diagram of a cross-section of a cell in an APD array consistent with embodiments of the present disclosure;

FIG. 9 is a schematic diagram of a hybrid integrated circuit chip including an APD array chip bonded to a ROIC chip consistent with embodiments of the present disclosure;

FIG. 10 is a schematic diagram of a plan view layout of a cell in an APD array including a complimentary metal-oxide-semiconductor (CMOS) image sensor (CIS) cell consistent with embodiments of the present disclosure;

FIG. 11 is a schematic diagram of a cross-section of a cell in an APD array including a CIS cell consistent with embodiments of the present disclosure;

FIG. 12 is a schematic diagram of a color filter array sensor consistent with embodiments of the present disclosure; and

FIG. 13 is a flow chart of an exemplary method that may be performed for detecting and ranging an object consistent with embodiments of the present disclosure.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

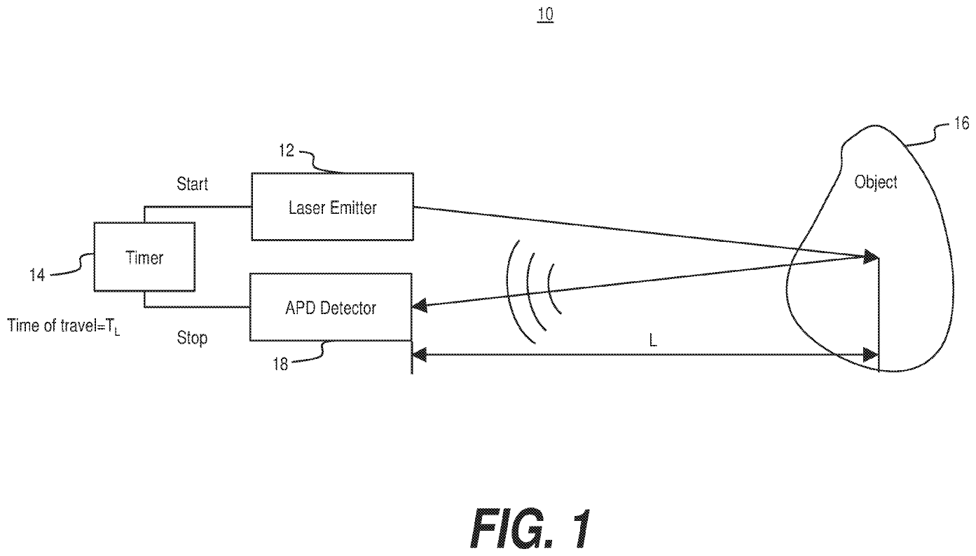

FIG. 1 shows a schematic diagram of an exemplary LIDAR system 10. Laser emitter 12 in exemplary LIDAR system 10 emits a laser beam which impinges upon a surface of an object 16. The laser beam reflects from object 16 and is received by an APD detector 18 of LIDAR system 10. Laser emitter 12 and APD detector 18 are synchronously clocked by timer 14 to enable calculation of a round-trip time of travel TL upon detection of the laser beam at APD detector 18. Based on the round-trip time of travel TL, a distance L between object 16 being detected and LIDAR system 10 may be calculated. LIDAR system 10 may be incorporated as part of a mechanical assembly, and may be configured to detect several different times of travel TL and calculate several distances L representative of multiple different points along the surface of object 16.

There exist multiple types of conventional LIDAR. In addition to the aforementioned time-of-flight (TOF) LIDAR, there exists frequency modulated continuous wave (FMCW) LIDAR. TOF LIDAR measures a time TL for transmitted and received laser pulses; and is therefore typically found in long range implementation. FMCW LIDAR systems may be prevalent in shorter range applications, where superior imaging is required. In a FMCW LIDAR system, the frequency of laser beam coming out of the emitter changes over time. Based on the frequency-time relationship in the emitted laser beam, the round-trip travel time may be calculated from the difference in frequency between emitted laser beam and as-received reflected laser beam, and consequently the distance to the target object can be calculated.

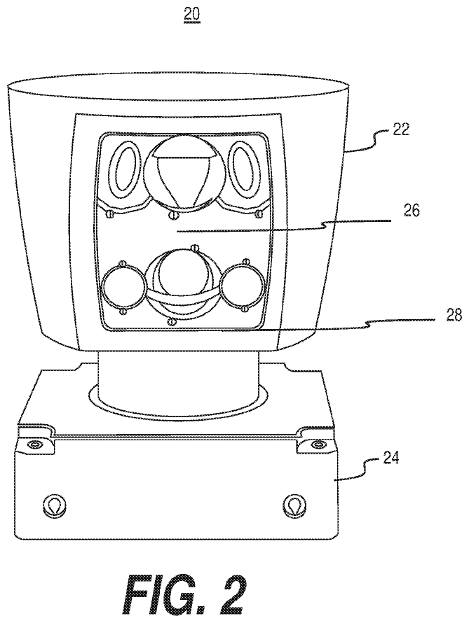

FIG. 2 is a diagrammatic illustration of an exemplary mechanical rotatable LIDAR system 20. LIDAR system 20 may include two mechanical parts such as an upper scanning mechanism 22 and a fixed lower part 24. The upper mechanism 22 may include an array of laser emitters 26 and an array of APDs 28. During operation, upper scanning mechanism 22 may rotate 360 degrees at a predetermined frequency, such as 20 Hz, and emit and detect light in accordance with LIDAR system 10 of FIG. 1. At a given time, only a single pair of laser-APD operates to emit and detect light. As a result, LIDAR system 20 may be unable to efficiently acquire full and complete information representative of distances of a target object, even at high frequencies of rotation. Moreover, a scan rate of upper scanning mechanism 22 may be limited due to mechanical assembly. Furthermore, reliability of the mechanical rotatable LIDAR system 20 is poor.

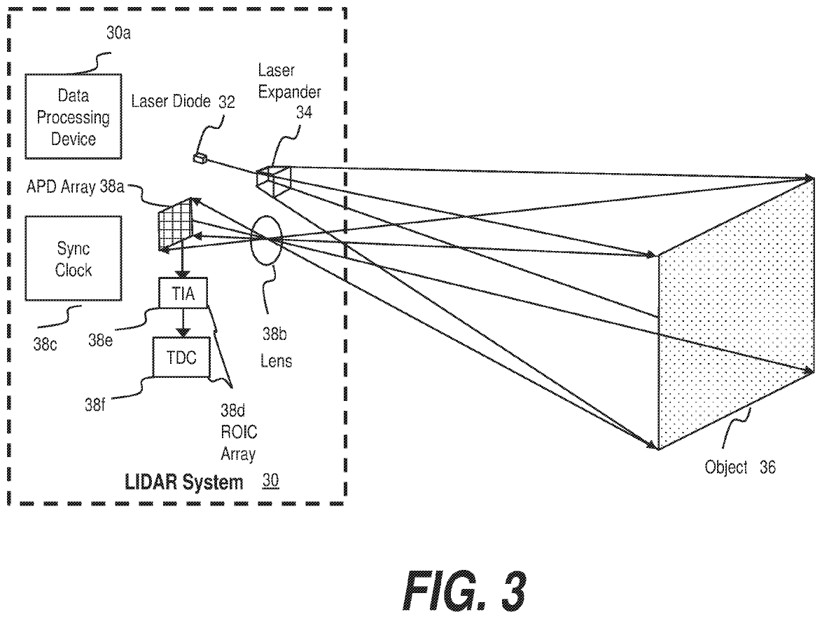

FIG. 3 is a schematic diagram of an exemplary system for detecting and ranging an object consistent with embodiments of the present disclosure. As shown in FIG. 3, a LIDAR system 30 may include a laser diode 32, a laser expander 34, an APD array 38a, a lens 38b, a synchronous clock 38c, and a readout integrated circuit (ROIC) or a ROIC array 38d. Each ROIC may include a transimpedance amplifier (TIA) 38e and a time-to-digital converter (TDC) 38f. ROIC may also include a high speed analog-to-digital converter (ADC) and digital signal processing (DSP) (not shown). Laser diode 32 may emit a laser beam, and laser expander 34 may diverge and uniformly distribute the emitted laser beam. Laser diode 32 may include a conventional laser diode, a vertical cavity surface emitting laser (VCSEL), a laser diode array, or any laser emitting light of an infrared or other wavelength. VCSEL may be implemented as a wafer surface level array laser, and a wavelength temperature coefficient for the laser may be small, including for example, below ⅕ of the wavelength temperature coefficient of a conventional laser. Multiple wavelength temperature coefficients may be contemplated. Laser diode 34 may also emit light at multiple wavelengths, including, for example, at 905 nm or 1550 nm. A high power light emitting diode (LED) packaged as a multi-die chip to improve light uniformity may also be used as a light source.

Laser expander 34 may include one or more optical lenses allowing for expansion of the laser light beam. One or more optical lenses may include at least one of a reflective lens type, a transmission lens type, a holographic filter, and a microelectromechanical system (MEM) micro lens. Other lens types are contemplated. Laser expander 34 may expand the laser light beam to cover a two-dimensional area of a target scene including one or more target objects. As shown in FIG. 3, expanded light from laser expander 34 may also impinge upon a surface of an object 36. Diffuse reflection may occur when the diverged laser reaches the surface of object 36, and a portion of the reflected laser beam may reach lens 38b of LIDAR system 30. Based on image formation at lens 38b, the reflected laser beam may be transmitted to APD array 38a.

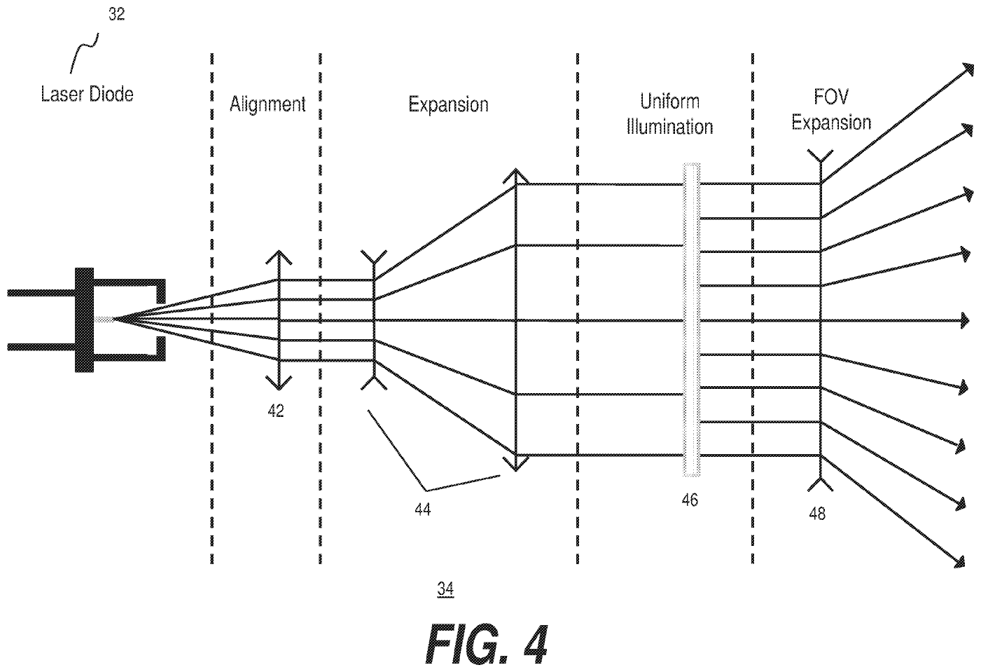

FIG. 4 is a schematic diagram of an exemplary system for laser alignment, laser expansion, uniform illumination, and FOV expansion consistent with embodiments of the present disclosure. As shown in FIG. 4, laser expander 34 may include one or more optical lenses 42 for laser beam alignment, lens 44 for laser beam expansion, lens 46 for uniform illumination, and lens 48 for field of view (FOV) expansion, Laser diode 32 may emit a laser light beam incident upon lens 42 for laser alignment. After laser beam alignment, the emitted laser light beam may be incident upon one or more lenses 44 for laser beam expansion. After expansion, the emitted laser light beam may be incident upon lens 46 for uniform illumination. Finally, after uniform illumination, the emitted laser light beam may be incident upon lens 48 for FOV expansion. After FOV expansion, the emitted laser light beam may be transmitted to cover an expanded angle of a target scene including one or more target objects 36 (as shown in FIG. 3). Laser expander 34 may also include other reflective and transmission types of optical lenses.

During laser beam expansion, a laser beam may also be reflected using a microelectromechanical system (MEMs) micro lens capable of 2-D angle adjustment. Further, the angle of the laser beam may be constantly varied to expand into a 2-D angle by constantly driving MEMs micro lens to change the angle of its lenses with respect to the laser beam. In addition, a single laser beam similar to an expanded beam may be obtained by forming multiple beams using a laser diode array. A single holographic filter may also form a large angle laser beam from multiple sub-laser beams. Laser expander 34 may also include a single or multiple stages of light modulation for one or more laser beams emitted from laser diode 32.

After expansion by laser expander 34, the laser beam may impinge upon object 36, and may be reflected back to LIDAR system 30 for APD array 38a detection (as shown in FIG. 3). APD array 38a and ROIC (array) 38d may be integrated in a plurality of pixels, and each pixel may include a side-by-side layout or a vertically stacked layout for each APD and ROIC. APD array 38a and ROIC (array) 38d may be integrated on a silicon-based chip having a detection wavelength of 905 nm. APD array 38a and ROIC (array) 38d may alternatively be integrated on a non-silicon-based chip having a detection wavelength of 1,550 nm. ROC (array) 38d may be coupled to read signals from APD array 38a. APD array 38a may be connected to TIA 38e and TDC 38f circuits. Light from laser diode 32 may be incident upon APD array 38a, which generates photoelectric signals. TIA 38e may amplify the output from APD array 38a to a usable voltage. TDC 38f may provide a digital representation of a time of arrival of each detected laser pulse received at APD array 38a. A data processing device 30a in LIDAR system 30 may process the signals and data received from ROIC (array) 38d to determine if object 36 has been detected. Synchronous clock 38c may measure an elapsed time from light being emitted from laser diode 32 to the reflection reaching APD array 38a. Synchronous clock 38c may communicate the measured time to data processing device 30a. Based on the measured time, data processing device 30a may calculate a distance between object 36 and LIDAR system 30. LIDAR system 30 may scan, frame by frame, to obtain complete information of distances to points on object 36. Data processing device 30a may generate a three-dimensional point cloud representing the depth information of points on object 36. LIDAR system 30 may further include an image sensor so that a two-dimensional image of object 36 may be simultaneously captured, for example, by an image sensor.

Data processing device 30a may include one or more components, for example, a memory and at least one processor. Memory may be or include at least one non-transitory computer readable medium and may include one or more memory units of non-transitory computer-readable medium. Non-transitory computer-readable medium of memory may be or include any type of volatile or non-volatile memory device, for example including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Memory units may include permanent and/or removable portions of non-transitory computer-readable medium (e.g., removable media or external storage, such as an SD card, RAM, etc.).

LIDAR system 30 may be configured to enable communications of data, information, commands, and/or other types of signals between data processing device 30a and off-board entities, LIDAR system 30 may include one or more components configured to send signals, such as transmitter or transceivers (not shown) that are configured to carry out one- or two-way communication. Components of LIDAR system 30 may be configured to communicate with off-board entities via one or more communication networks, such as radio, cellular, Bluetooth, W-Fi, RFID, and/or other types of communication networks usable to transmit signals indicative of data, information, commands, and/or other signals representative of measured object distance and associated information. For example, LIDAR system 30 may be configured to enable communications between devices for providing input for controlling laser diode 32 as part of LIDAR system 30 in an unmanned aerial vehicle (UAV) or autonomous automobile.

In some embodiments, off-board entities may include an interactive graphical user interface (GUI) for displaying 2-D object images and 3-D point clouds representative of depth information relating to target object 36, GUI may be displayable on a display device or a multifunctional screen and may include other graphical features, such as interactive graphical features (e.g., graphical buttons, text boxes, dropdown menus, interactive images, etc.) for viewing and display of the 2-D object images and 3-D point clouds. Other types of graphical display of the target object 36 data are contemplated.

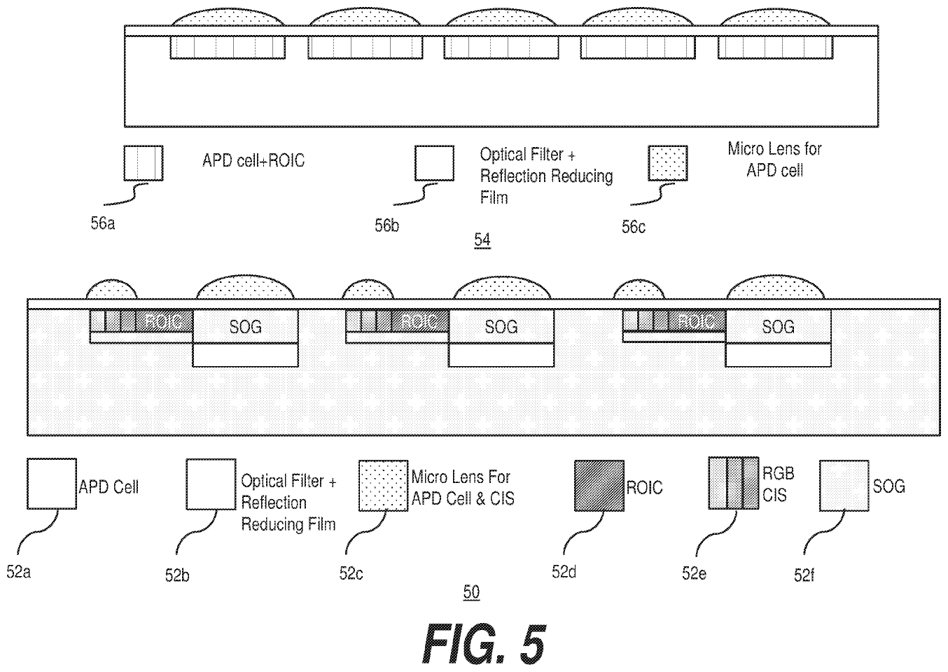

FIG. 5 includes a schematic diagram of a cross-section of a portion of an integrated circuit chip 50 including an APD array consistent with embodiments of the present disclosure. As shown in FIG. 5, a cross-section of a portion of an integrated circuit chip 50 may include one or more APD cells 52a, optical filter and reflection reducing film 52b, one or more micro lenses 52c for APD cell and complimentary metal-oxide-semiconductor (CMOS) image sensor (CIS), one or more ROIC cells 52d, one or more CIS cells 52e, and a spin-off-glass (SOG) 52f. Optical filter and reflection reducing film 52b may be superimposed upon one or more APD cells 52a. FIG. 5 also includes a cross-section of a portion of an integrated circuit chip 54 without a CIS that may include one more APD and ROIC integrated cells 56a, optical filter and reflection reducing film 56b, and one or more micro lenses 56c. Optical filter and reflection reducing film 56b may cover the entire pixel layer including APD and ROIC integrated cells 56a. Micro lenses 56c may cover and be vertically superimposed upon portions of optical filter and reflection reducing film 56b directly above each of APD and ROIC integrated cells 56a.

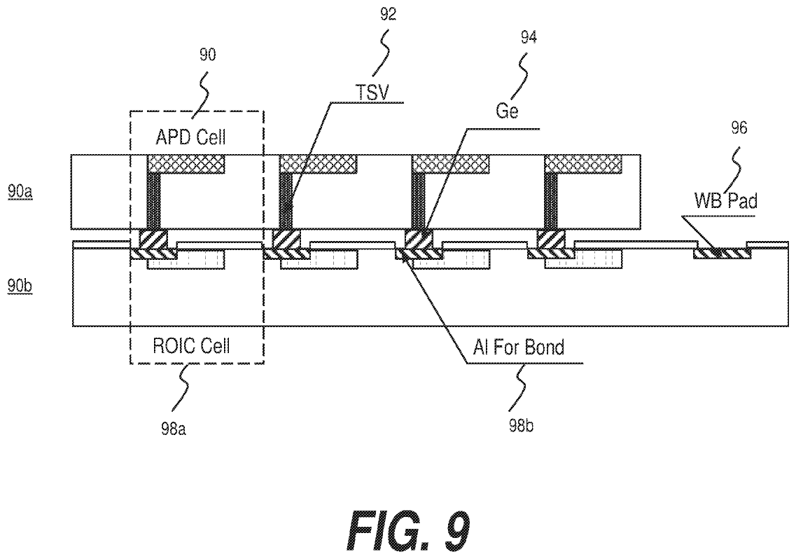

A plurality of APD cells 52a and ROIC cells 52d may be integrated as an array on an integrated circuit chip 50 using CMOS or a bipolar junction transistor complimentary metal-oxide-semiconductor (BiCMOS) technology. For example, integrated circuit chip 50 may include multiple rows and columns of pixels, each pixel including one APD cell 52a and a corresponding ROIC 52d. APD cells 52a and ROIC cells 52d may both adopt silicon-based technologies including a carrying substrate. The carrying substrate may comprise Si, Ge, or other substrate materials. Because both APD cells 52a and ROIC cells 52d may comprise Si, various types of incompatibilities (such as lattice incompatibility) between APD cells 52a and ROIC cells 52d may be avoided, thus maintaining APD cell 52a performance and yield. Integration of the array of APD cells 52a and ROIC cells 52d on the same integrated circuit chip 50 confers additional advantages including, for example, reduction in chip thickness as compared with a chip having a bonded structure (as shown in FIG. 9), Further, since APD cells 52a are sensitive to the 905 nm wavelength, and are adapted for a silicon-based solution, APD cells 52a are completely compatible with RIOCs 52d, allowing for efficiency of use and integration of the two components on the same production line.

Optical filter and layer of reflection reducing film 52b permits a preferred wavelength of 905 nm (short infrared) to pass through and be superimposed over APD cell 52a. Optical filter and layer of reflection reducing film 52b may have a thickness of ¼ of the laser beam wavelength (with a floating range of 10%), which may increase the transmission rate of the laser beam to allow for increased absorption by APD cell 52a. Other thicknesses to increase absorption are contemplated. Optical filter and layer of reflection reducing film 52b may filter incident beams by allowing beams having wavelengths close to that of laser diode 32 to pass through by adjusting one or more parameters. Further, micro lens 52c is positioned over optical filter and layer of reflection reducing film 52b and each APD cell 52a to align the laser beam with the APD cell 52a, thus improving APD cell 52a sensitivity. A light beam reaching micro lens 52c will completely reach APD cell 52a below micro lens 52c and will not refract to a neighboring APD cell 52a. Thus, cross-talk between APD cells 52a may be minimized.

Red-green-blue (RGB) CIS 52e may be positioned under micro lens 52c to capture a 2-D image in RGB color. Integrated circuit chip 50 as shown in FIG. 5 provides an enhanced configuration for directing light to APD cells 52a to detect target distance information while simultaneously integrating ROIC cells 52d to read from APD cells 52a and integrating RGB CISs 52e to capture 2-D RGB images. An oxide layer may also be included between APD cells 52a and ROIC cells 52d for signal isolation. The oxide layer may reduce leakage and parasitic capacitance. Including APD cells 52a and ROIC cells 52d in different layers also allows for an increase in signal isolation.

Also, spin-on glass (SOG) 52f (and/or a silicon nitride layer) may be used to make the surface of the pixel flat. In the example as shown in FIG. 5, SOG 52f is positioned on top of APD cell 52a to make the surface of pixel flat. Alternatively, other configurations may be used without limitation.

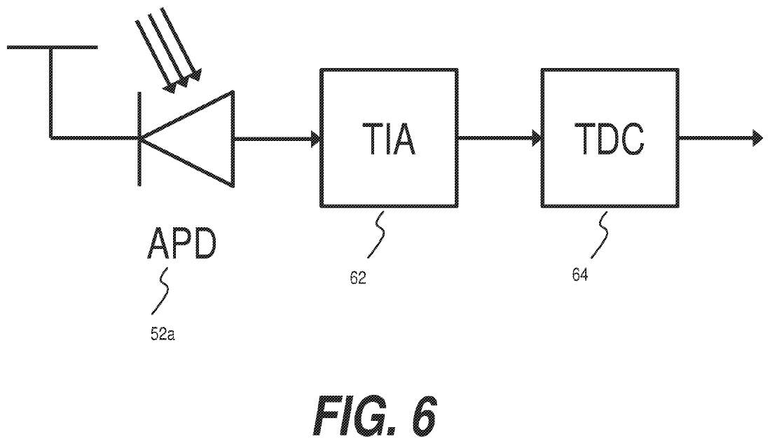

FIG. 6 is a schematic diagram of transimpedance amplifier (TIA) and time-to-digital converter (TDC) circuits consistent with embodiments of the present disclosure. As shown in FIG. 6, APD cell 52a is connected to TIA 62 and TDC 64 circuits. Light from laser diode 32 may be incident upon APD cell 52a, which generates photoelectric signals. TIA 62 amplifies the output from APD cell 52 to a usable voltage, and TDC 64 provides a digital representation of a time of arrival of each detected laser pulse received APD cell 52a for outputting photoelectric signals to data processing device 30a.

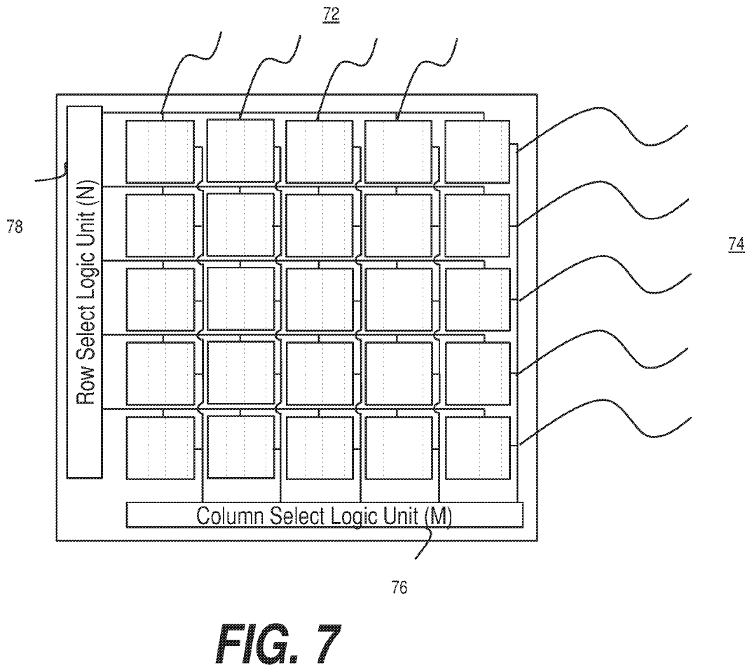

FIG. 7 is a schematic diagram of a partial plan view layout of integrated circuit chip 50. As shown in FIG. 7, a cell array is arranged in columns 72 and rows 74. A column selection logic unit 76 is used to select one of columns 72, and a row select logic unit 78 is used to select one of rows 74. A particular cell, including one APD cell 52a and one ROIC cell 52d as shown in FIG. 5, may be selected by specifying the corresponding column and row to column selection logic unit 76 and row selection unit 78, and signals or data from the selected cell may be transmitted to data processing device 30a. As a result, integrated circuit chip 50 having a selectable cell array provides for precise detection of multiple reflected laser beams, providing for parallel calculation of depth information of multiple points on target object 36.

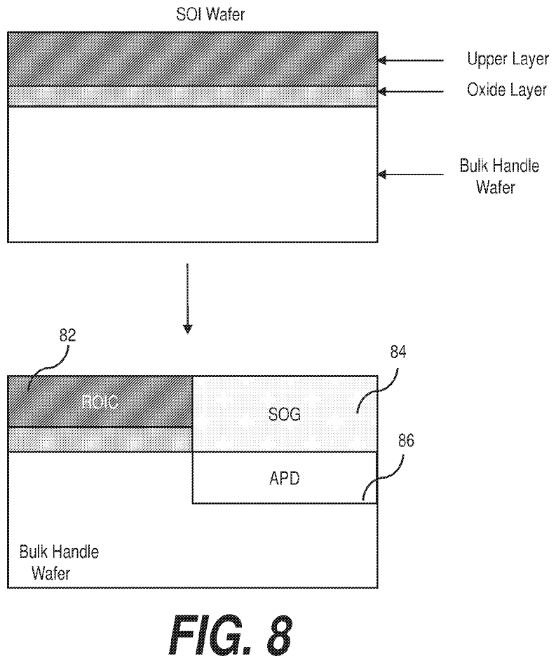

FIG. 8 is a schematic diagram of a cross-section of a cell in the cell array consistent with embodiments of the present disclosure. As shown in FIG. 8, each cell cross-section includes an ROIC cell 82, an SOG 84, and an APD cell 86. APD cell 86, which permits connections to ROIC cell 82, can be arranged separately from the circuitry (e.g. CMOS circuitry) For example, APD cell 86 and ROIC cell 82 can be arranged on different wafer layers that are separated via an insulation layer. Alternatively, APD cell 86 may be positioned laterally adjacent to ROIC 82 with necessary insulation.

As shown in FIG. 8, ROC cell 82 and SOG 84 may reside in the upper layer. An oxide layer is positioned beneath ROIC 82, and APD cell 86 is positioned in the bulk handle wafer. The oxide layer may reduce leakage and parasitic capacitance between ROIC 82 and APD cell 86. Moreover, because APD cell 86 and the corresponding ROIC cell 82 are integrated in monolithic silicon wafer technology, compatibility between the two components may be increased. In addition, because APD cell 86 is integrated as part of a silicon on insulated (SOI) wafer, APD cell 86 is positioned in bulk handle wafer, and ROIC cell 82 is positioned separately in upper 301 wafer, signal isolation may be increased. Each APD cell may be represented by a particular selection of a row and column pair (M, N) (as shown in FIG. 7), and the spatial configuration of each APD cell also allows for improved signaling in conjunction with TIA 62 and TDC 64 circuits (as shown in FIG. 6).

FIG. 9 is a schematic diagram of a hybrid integrated circuit chip including an APD array chip 90a bonded to an ROIC chip 90b consistent with embodiments of the present disclosure. Compared to the foregoing monolithic silicon-based integrated circuit chip with the integrated cell array (as shown in FIG. 5), the hybrid integrated circuit chip with APD array chip 90a bonded to ROIC chip 90b may be more flexible in design. Each of APD array chip 90a and ROIC 90b may be either silicon-based or non-silicon-based. APD array chip 90a and ROIC chip 90b may be processed together, or processed separately, prior to their bonding.

As shown in FIG. 9, APD array chip 90a may include APD cells 90, through-silicon via (TSV) 92, and Germanium (Ge) contact 94. ROIC chip 90b may include wire bonding (WB) pad 96, aluminum (Al) for bonding 98, and ROIC cells 98a. TSV 92 may allow for sending signals from a front side of APD array chip 90a of the hybrid integrated circuit chip to a back side of APD array chip 90a. APD array chip 90a and ROIC chip 90b may be fabricated using independent processes, and may be bonded to form an integral physical and electrical connection. The bonding may ensure alignment, prevent wafer fracture, and maintain effective electrical conduction, and may also be of significant mechanical strength, and ensure consistency of bonding at edges. APD array chip 90a may include any number of rows and columns (M×N) of APD cells 90, which may operate individually. Similarly, ROIC chip 90b may include the same number of ROIC cells 98 as and corresponding to APD cells 90, The integration may provide one-on-one bonding between APD cells 90 and ROIC cells 98.

Al for Bond 98 and WB Pad 96 are exemplary metals in the chip bonding process. Al for Bond 98 may be used for bonding with Ge 94 located at the back of APD array chip 90a, and WB pad 96 may be used for wiring in packaging. APD array chip 90a and ROIC chip 90b may undergo wafer level bonding by eutectic bonding of Al for Bond 98 at the front window of CMOS ROIC 98 and Ge 94 at the APD array chip 90a backside at about 420 degrees. As a result, APD cell 90 signals may be efficiently transmitted to the corresponding ROIC cell 98. Compared with solder ball or indium brazing, Al—Ge eutectic bonding is advantageous because the bonding is strong and the bonded hybrid integrated circuit chip is miniaturized. Many methods may be used to bond the APD array chip 90a and ROIC chip 90b, but Al—Ge bonding is the most preferred. Other methods may be contemplated and include Al—Ge bonding, Au—Ge bonding, Au—Si bonding, Au—Sn bonding, In—Sn bonding, Al—Si bonding, Pb—Sn bonding.

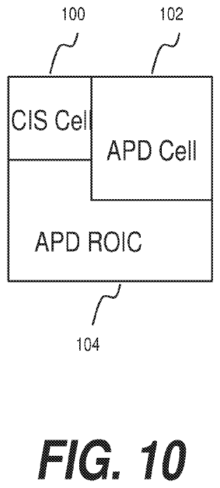

FIG. 10 is a schematic diagram of a plan view layout of a cell in the cell array including CMOS image sensor (CIS) cell consistent with embodiments of the present disclosure. As shown in FIG. 10, an APD cell 102 shown in plain view is integrated as part of a CIS cell 100 which includes an integrated image sensor. The cell in the cell array may include a combination of CIS cell 100, APD cell 102, APD ROIC 104, and CIS ROIC (not shown). CIS ROIC may be included below the layer including CIS cell 100, APD cell 102, and APD ROIC 104. For each pixel layout, CMOS image sensor (CIS) may be integrated therein. Therefore, each frame may be capable of generating simultaneously a 3-D point cloud image having depth information generated by APD cell 102, and a 2-D image generated by CIS 100. Objects and humans may be recognized based on CIS 100 capturing 2-D images.

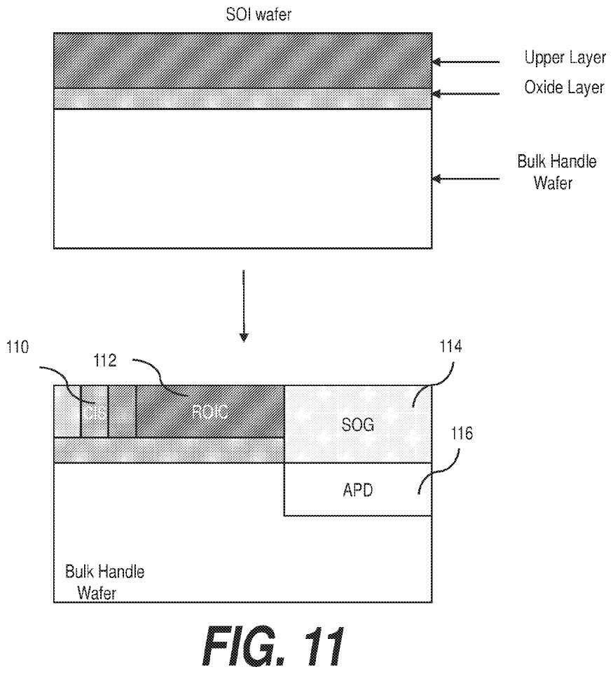

FIG. 11 is a schematic diagram of a cross-section of a cell in the cell array including a CIS cell consistent with embodiments of the present disclosure. As shown in FIG. 11, the cell in the cell array includes a CIS cell 110, a ROIC 112, a SOG 114, and a APD cell 116.

APD cell 116 is a single cell, and has a corresponding APD ROIC 112. APD cell 116 may be a single photon avalanche diode (SPAD), multiple single photon avalanche diodes (SPADs), or silicon photomultipliers (SiPM) for increasing dynamic range. APD cell 116, which permits connections to ROIC cell 112, may be arranged separately from the circuitry (e.g. CMOS circuitry). For example, the APD cell 116 and the ROIC cell 112 may be arranged on different wafer layers that are separated via an insulation layer. Alternatively, APD cell 116 may be positioned laterally adjacent to ROIC 112 with necessary insulation.

As shown in FIG. 11, CIS cell 110, ROIC cell 112 and SOG 114 may reside in the upper layer. An oxide layer is positioned beneath ROIC 112, and APD cell 116 is positioned in the bulk handle wafer. The oxide layer may reduce leakage and parasitic capacitance amongst CIS 110, ROIC 112, and APD cell 116. Moreover, because APD cell 116 and the corresponding CIS 110 and ROIC 112 may be integrated in silicon wafer technology, compatibility between the components may be increased. In addition, because the APD cell is integrated as part of a silicon on insulated (301) wafer, APD cell 116 is positioned in bulk handle wafer, and CIS 110 and ROIC 112 are positioned separately in upper 301 wafer, signal isolation may be increased.

Alternatively, APD cell 116 may reside in the upper layer, with CIS cell 110 and ROIC cell 112 positioned in the bulk handle wafer. In such a case, SOG 114 may be positioned on top of the CIS cell 110 and ROC cell 112 in order to make the surface for the pixel flat.

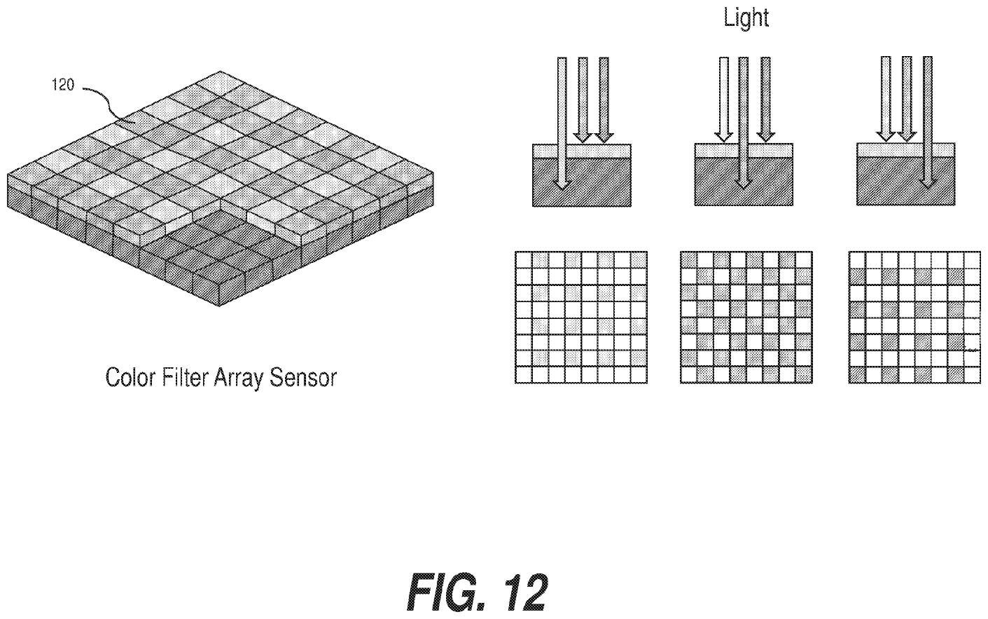

FIG. 12 is a schematic diagram of a color filter array sensor consistent with embodiments of the present disclosure. As shown in FIG. 12, color filter array sensor 120 filters visible laser light according to color, and only allows red (R), green (G), or blue (B) light to pass through filter 120. CIS cell 110 includes three individual RGB pixels. CIS 110 may be a set of RGB cells, or multiple sets of RGB cells, or may be black and white. RGB CIS 110 (red-green-blue image sensor) and ROIC 112 may be designed to be positioned over the upper layer of an integrated circuit chip and spaced from an APD cell 116 by an oxide layer to prevent an APD cell 116 from affecting CIS cell 110 when in operation (CIS cell 110 and APD cell 116 may be provided in different layers). Further, a ROIC 112 corresponding to CIS 110 may be positioned below the layer of cells. Other spatial arrangements may be contemplated. Color filter array sensor 120 may filter light to only allow for capturing 2-D images of desired colors.

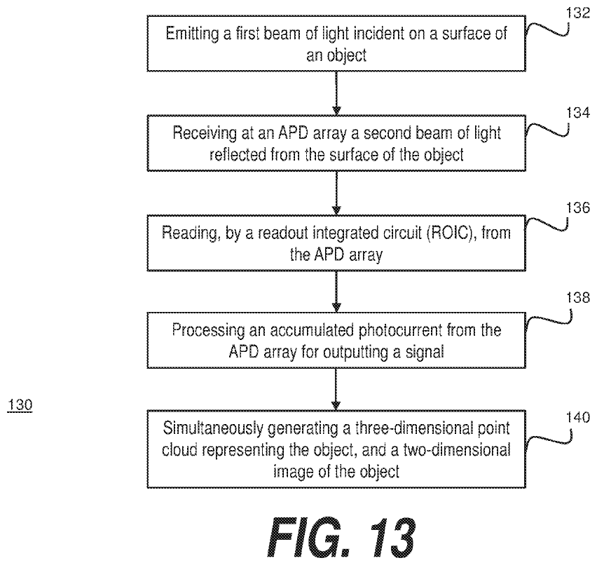

FIG. 13 is a flow chart of an exemplary method 130 that may be performed for detecting and ranging an object consistent with embodiments of the present disclosure. Method 130 may include a step of emitting, by a laser light source, a first beam of light incident on a surface of the object (step 132). Laser diode 32 may include a conventional laser diode, a vertical cavity surface emitting laser (VCSEL), a laser diode array, or any laser emitting light of an infrared wavelength, including for example, at 905 nm or 1,550 nm. The emitted light from the laser light source may be expanded, by laser beam expander 34 including one or more optical lenses. The one or more optical lenses may include at least one of a reflective lens type, a transmission lens type, a holographic filter, and a microelectromechanical system (MEM) micro lens. Laser expander 34 may also include one or more optical lenses 42 for laser beam alignment, lens 44 for laser beam expansion, lens 46 for uniform illumination, and lens 48 for field of view (FOV) expansion.

Method 130 may also include a step of receiving at APD array 38a a second beam of light reflected from object 36 (step 134). For example, the second beam of light reflected from object 36 may be received at lens 38b, wherein, based on image formation at lens 38b, the second beam of light may be transmitted to a hybrid integrated circuit chip including APD array chip 90a for detection. The integrated circuit chip may be formed from wafer level bonding including eutectic bonding of Al For Bond 98b at a front window of a ROIC cell 98a and eutectic bonding of Ge 94 at a backside of APD array chip 90a. The second beam of light may also be transmitted to a silicon-based integrated circuit chip 50 including a plurality of APD array cells 52a forming APD array 38a. APD array 38a may include a silicon-based chip having a detection wavelength of 905 nm. Both laser light source 32 and APD array 38a may be controlled by synchronous clock 38c.

Method 130 may also include the step of reading, by a ROIC 52d, from APD array 38a (step 136). TIA 62 and TDC 64 circuit arrangement (as shown in FIG. 6) allows for ROIC 52d to read from APD cell 52a. Data processing device 30a may be also configured to communicate with ROIC 52d to read from APD array 38a and generate photoelectric signals based on the reflected light detected at APD array 38a. Method 130 may also include the step of processing accumulated photocurrent from APD array 38a for outputting a signal (step 138). TIA 62 and TDC 64 circuit arrangement (as shown in FIG. 6) allows for ROIC 52d to read from APD cell 52a, and to efficiently process accumulated photocurrent from APD cell 52a (or an array) for outputting a signal representative of the distance of target object 36 detected by APD cell 52a.

Based on the processing, method 130 may also include the step of simultaneously generating, by a controller or data processing device 30a, a 3-D point cloud representing the object based on signals from ROIC 52d, and 2-D image of the object captured by an image sensor 52e (step 140). An interactive GUI for displaying 2-D object images and 3-D point clouds representative of depth information may be utilized to display information and the detected object. An interactive GUI may be displayable on a display device or a multifunctional screen and may include other graphical features, such as interactive graphical features (e.g., graphical buttons, text boxes, dropdown menus, interactive images, etc.) for viewing and display of the 2-D object images and 3-D point clouds. This information may then be used to detect and range a target object, and inform additional decisions.

It will be apparent to those skilled in the art that various modifications and variations may be made to the disclosed methods and systems. For example, UAVs may be equipped with the exemplary system detecting and ranging an object consistent with embodiments of the present disclosure. In particular, UAVs may be equipped to collect information and generate 3-D point cloud containing distance information and 2-D images of the object surface over a certain period of time or for the duration of travel from one location to another. In these circumstances, UAVs may be controlled in conjunction with information gathered to recognize, follow, and focus on target objects, such as people, vehicles, moving objects, stationary objects, etc, to achieve high-quality desirable images.

Other embodiments will be apparent to those skilled in the art from consideration of the specification and practice of the disclosed methods and systems. It is intended that the specification and examples be considered as exemplary only, with a true scope being indicated by the following claims and their equivalents.

1.-8. (canceled)

9. A system for detecting and ranging an object, comprising:
a laser light source configured to emit a first beam of light incident on a surface of the object;
an avalanche photodiode (APD) array configured to receive a second beam of light reflected from the surface of the object; and
a readout integrated circuit (ROIC) array coupled to read and process accumulated photocurrent from the APD array for outputting at least one signal representative of the object detected by the APD array.

10. The system of claim 9, further comprising a controller, the controller configured to generate a three-dimensional point cloud representing the object based on a plurality of the signals from the ROIC array.

11. (canceled)

12. The system of claim 9, further comprising a laser beam expander configured to expand the emitted first beam of light from the laser light source, the laser beam expander including one or more optical lenses.

13. The system of claim 12, wherein the one or more optical lenses includes at least one of a reflective type lens, a transmission type lens, a holographic filter, and a microelectromechanical system (MEMS) micro lens.

14. The system of claim 9, further comprising a lens at a receiver configured to receive the second beam of light reflected from the surface of the object, wherein the second beam of light is transmitted to the APD array through the lens.

15. The system of claim 9, wherein both the laser light source and the APD array are controlled by a synchronous clock.

16. (canceled)

17. The system of claim 9, further comprising a complementary metal-oxide-semiconductor (CMOS) image sensor (CIS) array.

18. The system of claim 17, wherein the APD array, the ROIC array, and the CIS array are integrated in a plurality of pixels, each pixel including an APD cell, a ROIC, and a CIS cell.

19. The system of claim 17, wherein the APD array is isolated from the CIS array.

20. The system of claim 19, wherein the APD array and the CIS array are positioned in different layers and separated by an insulating layer.

21. The system of claim 20, wherein the ROIC array and the CIS array are positioned in an upper layer, the APD array is positioned in a bulk handle wafer, and the insulating layer is an oxide layer.

22. The system of claim 20, wherein the APD array is covered by a transparent material and the insulating layer.

23. The system of claim 1922, wherein the APD array and the CIS array are positioned in the same layer.

24. The system of claim 9, wherein the APD array and the ROIC array are integrated on an integrated circuit chip based on silicon substrates.

25. The system of claim 24, wherein the APD array is isolated from the ROIC array.

26. The system of claim 25, wherein the APD array and the ROIC array are positioned in different layers and separated by an insulating layer.

27. The system of claim 26, wherein the ROIC array is positioned on an upper layer, the APD array is positioned in a bulk handle wafer, and the insulating layer is an oxide layer.

28. The system of claim 26, wherein the APD array is covered by a transparent material and the insulating layer.

29. (canceled)

30. The system of claim 9, further comprising a transimpedance amplifier (TIA) and a time-to-digital converter (TDC) circuit.

31.-38. (canceled)

39. The system of claim 17, wherein the CIS array includes a plurality of red-green-blue (RGB) cells.

40.-67. (canceled)
